(19) United States
(12) Patent Application Publication
(10) Pub. No.: US 2009/0307616 A1
(43) Pub. Date: Dec. 10, 2009

(54) USER INTERFACE, DEVICE AND METHOD FOR AN IMPROVED OPERATING MODE

(75) Inventor: Pia Breum Nielsen, Kobenhavn S (DK)

Correspondence Address: Perman & Green, LLP, 99 Hawley Lane, Stratford, CT, 06614, US

(73) Assignee: NOKIA CORPORATION, Nokia Group (FI)

(21) Appl. No.: 12/132,997

(22) Filed: Jun. 4, 2008

(51) Int. Cl. G06F 3/048; G06F 17/00

(52) U.S. Cl. 715/764; 707/104.1; 707/E17.001

(57) ABSTRACT

A user interface for controlling a device according to a first and a second operating mode. The user interface is configured to automatically switch from the first to said second operating mode at a scheduled time. The user interface is also configured to display a notification on a display, the notification indicating an option to postpone said automatic profile switch to a later scheduled time.

### FIELD

The present application relates to a device and a method for operating modes, and in particular to a device and a method for switching operating modes.

### BACKGROUND

More and more electronic devices such as mobile phones, MP3 players, Personal Digital Assistants (PDAs) are becoming smaller and smaller while having more and more information stored and/or accessible through them. Users are relying on these devices and becoming all the more dependent on them. Due to this they are designed to be small and easy to carry around. However, as the user carries his device with him he will sometimes be in situations or environments where the standard settings of the device is not suitable, for example the ringing tone may be too loud, too soft or perhaps the device shouldn't make any sound at all. But, to change the settings for each occasion can be a difficult task for some users and it is surely a time and cognitive effort consuming task that needs to be repeated each time the user wants to change environment.

Contemporary devices have solved this by implementing devices with pre-defined and customizable setting modes, also commonly referred to as profiles. Each of these profiles contain a set of parameters controlling features such as ringing tune, ringing volume, incoming message alert, vibrator or vibra alert etc. This has provided a possibility for users to quickly change more than one setting at a time.

The environments in which these devices are used are also becoming more and more hectic with higher demands on fast access and multitasking, and not only in a professional environment but also in private and social environments. For example a user should be able to read a book, while holding a grocery bag in a rattling subway train and still be able to access the information stored in the device for the device to live up to the many requirements posed upon it by a user buying and using the device. This poses strict requirements on fast and easy access to data and functions.

Prior art solutions for mobile phones include the possibility of associating a profile with a calendar item so that a specified profile or operating mode will be activated as a calendar event is triggered and then deactivated as the calendar event lapses.

This provides a user with the possibility of not having to remember to switch the profile to a more silent one as he enters a meeting room. The phone or other device will take care of this for the user as long as the event is listed in the calendar.

This has the disadvantage that should a meeting not according to the scheduled times the profile will be changed back while the meeting is still taking place which can lead to an annoying and/or embarrassing situation.

Other solutions are designed to activate a certain profile as a room is entered, often utilizing Bluetooth™ technology. This allows for the possibility of having all devices (or at least those that are set or programmed accordingly) to switch to a certain profile, such as silent, as the device is brought into a meeting room.

This has the disadvantage that it only applies to some meetings, ie those that are held in specific meeting rooms that are equipped correspondingly and it can be difficult for a user to remember which rooms are so equipped and it is also easy for a user most often having meetings in meeting rooms that are correctly equipped to become complacent which can lead to an annoying or embarrassing situation as such a user attends a meeting at a meeting room not being properly equipped.

Also, during night a user will be less prone to use his mobile device as it is assumed that he will be in bed sleeping and allowing the phone to run on full power during this time is a waste of power and the battery will be drained unduly. Prior art devices have therefore been designed to turn down certain systems while not in use so as to save power. If a user then wants to have access to his phone, for example to check the time, he needs to physically grab the device and activate it. After another timeout period the device will again partially shut itself off or rather go into sleep mode as it is commonly referred to.

This has a disadvantage that the user actively has to activate the device and also that the phone will be shining brightly for a period of time which may be disturbing to others.

A device that allows an easy way to change the profile or operating mode on while not requiring additional hardware and which is easy and intuitive to learn would thus be useful in modern day society.

### SUMMARY

On this background, it would be advantageous to provide a device and a method that overcomes or at least reduces the drawbacks indicated above by providing a user interface configured to automatically switch profile at a scheduled time and offer a user an opportunity postpone the switch.

This provides an intuitive way of having an appropriate profile or operating mode active in a device while taking into account of various environmental requirements regarding scheduled events and which is both easy and intuitive to use and to learn and also easy to deduce from trial and error usage of a device.

The disclosed embodiments provide a user interface for controlling a device according to a first and a second operating mode which user interface is configured to automatically switch from said first to said second operating mode at a scheduled time, wherein said user interface is further configured to display a notification on a display, said notification indicating an option to postpone said automatic profile switch to a later scheduled time.

In one embodiment the user interface is further configured to receive user input and configured to automatically postpone said automatic profile switch if no user input is received within a timeout period.

This allows a user to ignore any indications and thereby focus on other things at hand such as attending a meeting while the user interface remains in a wanted operating mode.

In one embodiment the user interface is further configured to receive user input and configured to automatically execute said automatic profile switch if no user input is received within a time out period.

This allows a user to have his user interface operating in a wanted operating mode without having to check for notifications given by the user interface.

In one embodiment the user interface is further configured to display a graphical indication of when said automatic profile switch is scheduled to be executed.

This provides an indication to a user that a profile switch is imminent and provides the user with ample time to postpone said profile switch.

In one embodiment the notification is graphical and in one embodiment this graphical notification is a pop-up box.

In one embodiment the notification is a pre-recorded or synthesized voice message. This provides a user with information regarding said profile switch without requiring the user to move focus and look at his device.

In one embodiment the user interface is further configured to display a graphical indication of said option to postpone said scheduled profile switch, wherein said graphical indication is a softkey label.

The aspects of the disclosed embodiments are also directed to providing a device incorporating and implementing or configured to incorporate and implement a user interface according to above.

In one embodiment the device is a mobile communication terminal or a personal digital assistant.

Such a device has the same advantages of the user interface above.

The aspects of the disclosed embodiments are also directed to providing a user interface comprising means for executing a device according to a first and a second operating mode, said user interface further comprising means for automatically switching from said first to said second operating mode at a scheduled time, and means for displaying a notification, said notification indicating an option to postpone said automatic profile switch to a later scheduled time.

The aspects of the disclosed embodiments are also directed to providing a computer readable medium including at least computer program code for controlling a user interface, said computer readable medium comprising software code for controlling a user interface, said computer readable medium comprising software code for automatically switching from a first to a second operating mode at a scheduled time, and software code for display a notification on a display, said notification indication an option to postpone said automatic profile switch to a later scheduled time.

The aspects of the disclosed embodiments are also directed to providing a device incorporating and implementing a computer readable medium according to above.

The aspects of the disclosed embodiments are also directed to providing a method for automatically switching from a first operating mode to a second operating mode comprising determining whether a scheduled profile switch is to be executed, displaying a notification on a display wherein said notification indicates an option to postpone said automatic switch, receiving user input and executing said profile switch according to said user input.

This method and the embodiments below have the same advantages as are outlined above.

In one embodiment the method further comprises automatically postponing said automatic profile switch if no user input is received within a time out period.

In one embodiment the method further comprises automatically executing said automatic profile switch if no user input is received within a time out period.

In one embodiment the method further comprises displaying a graphical indication of when said automatic profile switch is scheduled to be executed.

In one embodiment the method further comprises displaying a graphical indication of said option to postpone said scheduled profile switch, wherein said graphical indication is a softkey label.

The aspects of the disclosed embodiments are also directed to providing a device incorporating and implementing or configured to incorporate and implement a method according to above.

On this background, it would also be advantageous to provide a device and a method that overcomes or at least reduces the drawbacks indicated above by providing a data structure comprising control settings wherein said control settings include audio settings for notifications, vibra settings and display illumination settings.

In one embodiment the display illumination settings comprise at least one color setting and/or a contrast setting.

In one embodiment the data structure further comprises settings for controlling execution of applications.

The aspects of the disclosed embodiments are also directed to providing a device incorporating and implementing or configured to incorporate and implement a user interface according to above.

On this background, it would also be advantageous to provide a device and a method that overcomes or at least reduces the drawbacks indicated above by providing a user interface configured to incorporate a data structure according to above as an operating mode.

This operating mode is hereafter referred to as a night profile or a night operating mode.

The night profile or night operating mode thus do not only change the sound and vibrator settings for a device or its user interface, but also the display illumination, the applications currently running, the scheduling of routine activities and thusly changes the operation of the device profoundly and not only superficially so as to reduce the power consumption or drainage and the user interface's influence on the surrounding environment as well as the accessibility of data.

This provides an intuitive way of maintaining access to data and functions needed while reducing the power consumption and the influence on the surrounding that is both easy and intuitive to use and to learn and also easy to deduce from trial and error usage of a device.

In one embodiment the user interface is further configured to receive motion data and from this motion data determine a position change and automatically switch to said operating mode according to said position change.

This provides for a quick and easy way of changing to a special operating mode which is easy to use and learn and easy to deduce.

In one embodiment the user interface is further configured to update a display according to said determined position change. This allows a user to easily perceive data displayed on a display regardless of the position of a device incorporating the user interface.

In one embodiment the user interface is further configured to receive light data and according to said light data automatically switch to said operating mode. This provides for a possibility of switching to a night profile when it is detected that the user interface is in night-like conditions.

In one embodiment the user interface is further configured to receive sound data and according to said sound data automatically switch to said operating mode. This provides for a possibility of switching to a night profile when it is detected that the user interface is in night-like conditions.

In one embodiment the user interface is further configured to activate an alarm clock application as said operating mode is switched to. This allows for an easy coupling of two associated applications and for a user to set an alarm clock function easily.

In one embodiment the user interface is further configured to execute a scheduling application and to switch to said operating mode according to a scheduled event comprised in said scheduling application. This provides for a possibility of controlling a user interface to enter a special operating mode even regardless of other factors.

The aspects of the disclosed embodiments are also directed to providing a device incorporating and implementing or configured to incorporate and implement a user interface according to above.

In one embodiment the device is a mobile communication terminal or a personal digital assistant.

Such a device has the same advantages of the user interface above.

The aspects of the disclosed embodiments are also directed to providing a method for controlling a user interface, said method comprising activating an operating mode comprising a data structure according to above and controlling an illumination of a display according to control settings comprised in said data structure.

This method and the embodiments below have the same advantages as are outlined above.

In one embodiment the method further comprises receiving motion data and from this motion data determine a position change and automatically switch to said operating mode according to said position change.

In one embodiment the method further comprises receiving light data and according to said light data automatically switch to said operating mode.

In one embodiment the method further comprises receiving sound data and according to said sound data automatically switch to said operating mode.

In one embodiment the method further comprises activating an alarm clock application as said operating mode is switched to.

In one embodiment the method further comprises executing a scheduling application and switching to said operating mode according to a scheduled event comprised in said scheduling application.

The aspects of the disclosed embodiments are also directed to providing a device incorporating and implementing or configured to incorporate and implement a method according to above.

In one embodiment the device is a mobile communication terminal or a personal digital assistant.

Such a device has the same advantages of the method above.

The aspects of the disclosed embodiments are also directed to providing a computer readable medium including at least computer program code for controlling a user interface, said computer readable medium comprising software code for activating an operating mode comprising a data structure according to above and controlling an illumination of a display according to control settings comprised in said data structure.

The aspects of the disclosed embodiments are also directed to providing a device incorporating and implementing a computer readable medium according to above.

The aspects of the disclosed embodiments are also directed to providing a user interface according to claim the first aspect above wherein said first operating mode comprises a data structure according to above.

The aspects of the disclosed embodiments are also directed to providing a device incorporating and implementing or configured to incorporate and implement a user interface according to above.

In one embodiment the device is a mobile communication terminal or a personal digital assistant.

Such a device has the same advantages of the user interface above.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIG. 2 is a plane front view of a device according to an embodiment,

FIG. 3 is a block diagram illustrating the general architecture of a device of FIG. 2 in accordance with the present application,

FIGS. 4A, B, C, D, E and F are screen views of a device according to an embodiment,

FIGS. 5A and B are flow charts describing a method according to an embodiment,

FIGS. 6A, B and C are plane views of a device according to an embodiment,

FIG. 7 is a flow chart describing a method according to an embodiment and

FIG. 8 is a flow chart describing a method according to an embodiment.

### DETAILED DESCRIPTION

In the following detailed description, the device, the method and the software product according to the teachings for this application in the form of a cellular/mobile phone will be described by the embodiments. It should be noted that although only a mobile phone is described the teachings of this application can also be used in any electronic device such as laptops, PDAs, mobile communication terminals, electronic books and notepads and other electronic devices offering access to information.

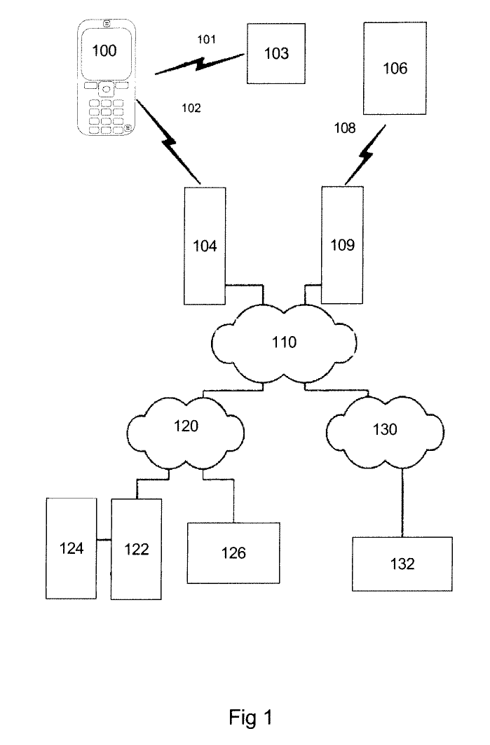

FIG. 1 illustrates an example of a cellular telecommunications system in which the teachings of the present application may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, etc. The local devices 103 can for example be various sensors that can communicate measurement values to the mobile terminal 100 over the local link 101.

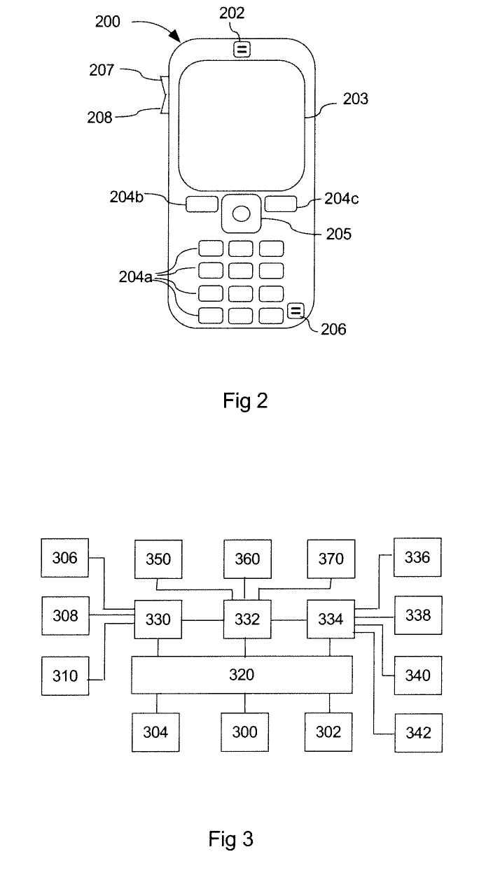

An embodiment 200 of the mobile terminal 100 is illustrated in more detail in FIG. 2. The mobile terminal 200 comprises a speaker or earphone 202, a microphone 206, a main or first display 203 and a set of keys 204 which may include a keypad 204a of common ITU-T type (alpha-numerical keypad representing characters “0”-“9”, “*” and “#”) and certain other keys such as soft keys 204b, 204c and a joystick 205 or other type of navigational input device. The device is also equipped with one or two volume keys 207 and 208. If one key 207 is used it is usually a two-way key each direction being associated with either volume up or volume down. If two keys are used one is associated with volume up 207 and the other with volume down 208.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a calendar application 360, as well as various other applications 370, such as applications for voice calling, video calling, sending and receiving Short Message Service (SMS) messages, Multimedia Message Service (MMS) messages or email, web browsing, an instant messaging application, a phone book application, a notepad application, a control panel application, a camera application, one or more video games, etc. It should be noted that two or more of the applications listed above may be executed as the same application

The MMI 334 also includes one or more hardware controllers, which together with the MMI drivers cooperate with the first display 336/203, and the keypad 338/204 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

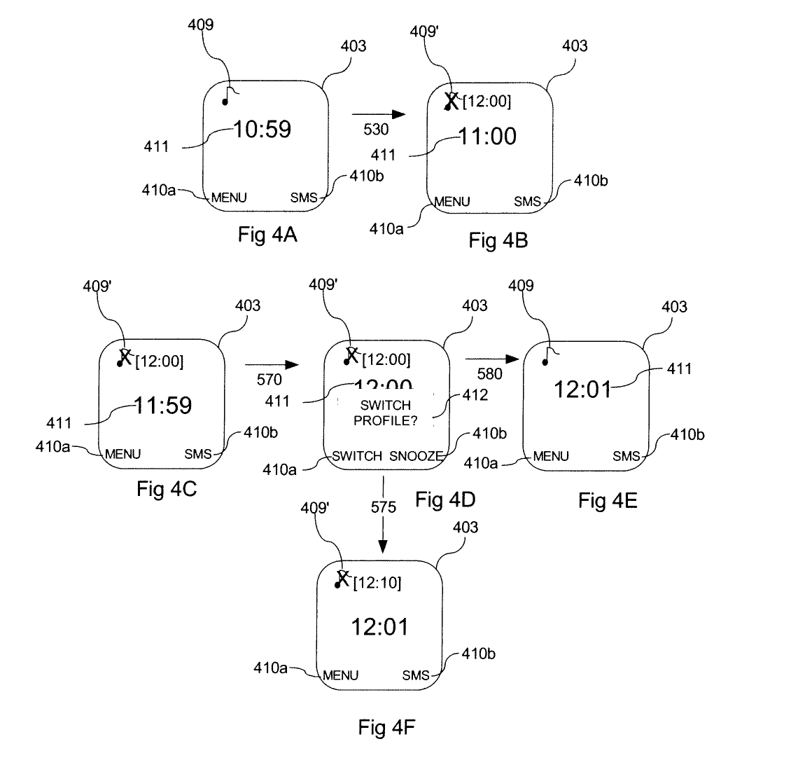

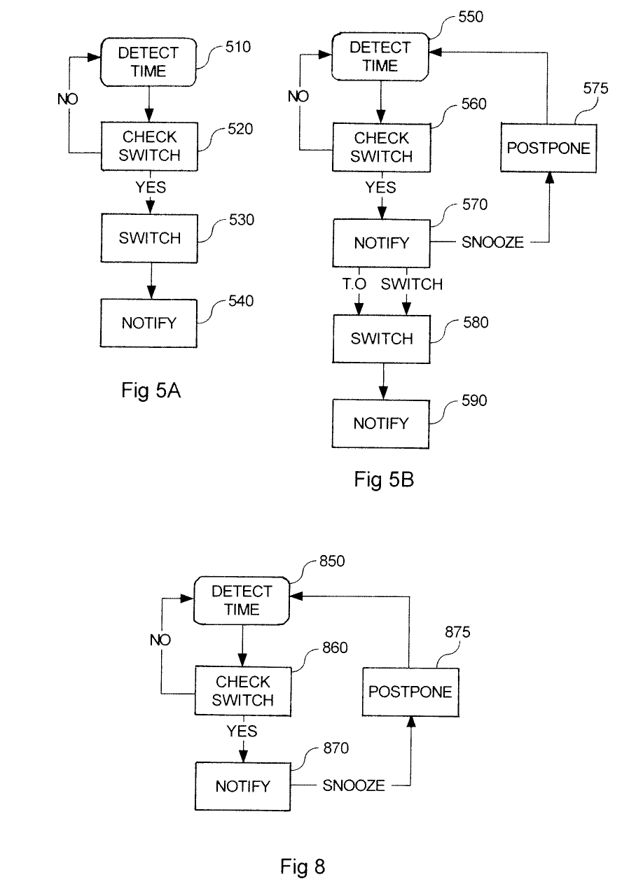

FIG. 4A shows a screen view of a user interface in a device (ref 200 in FIG. 2) according to the teachings herein which will be described with simultaneous reference to FIG. 5, which shows a flow chart of a method according to the teachings herein. The device (200) is, in this exemplary embodiment, a mobile phone such as is described with reference to FIG. 2. Above the two softkeys referred to as 204b and 204c in FIG. 2 (not shown in FIG. 4) there are arranged two softkey labels 410a and 410b on a display 403 which labels indicate which function will be activated as the associated softkey is pressed. In this embodiment the functions are to open an options menu (MENU) and to open a message editor for Short Message Services (SMS).

In one embodiment the screen or display view 403 shows a graphical representation of data 411, in this example the time of day, 10:59, see FIG. 4A. A graphical indication 409 of the currently used profile is also displayed. In this example the graphical indication is in the form of a note indicating that the profile gives audible notifications. In a first step 510 the local time is determined by the controller (300 in FIG. 3) and this time is checked in step 520 against a scheduling application such as a calendar application 360 (in FIG. 3). If there is no event scheduled to switch the profile a new time is determined by returning to step 510.

If there is an event in the scheduling application that dictates a profile switch the profile switch is executed in step 530 automatically switching to another profile. In this example this will happen as the local time changes from 10:59 to 11:00. The user is thereafter notified of this profile switch in step 540. In this embodiment the notification is made by displaying a different or updated graphical indication 409′, see FIG. 4B. In this embodiment the graphical indication is in the form of a crossed over note indicating that only non-audible notifications are given. The data displayed 411 is also updated to show the local time 11:00.

In one embodiment (as is shown in FIG. 4B) the graphical indication also displays a time when the automatically switched to profile will lapse, in this example 12:00. This notifies to the user both that an automatically induced profile is currently active and that it will lapse at a certain time.

As the local time progresses it is regularly determined in step 550 and checked against a scheduling application such as the calendar application in step 560. If no such event is found, a new time is determined by returning to step 550. In our example the next scheduled event is at 12:00 as is also indicated by the graphical indication 409′, see FIG. 4C. As the time is determined to be 12:00 in step 550 it will receive a match in the checking step of 560 and a notification will be displayed to a user in step 570. In this example the notification is in the form of a pop-up box 412 which carries the text “SWITCH PROFILE?”. The soft key labels 410a and 410b are also updated to display the functions of SWITCH and SNOOZE, see FIG. 4D.

Alternatively only the soft key labels 410 need be updated or a notification can be given without said pop-up box 412 by changing the text displayed 411 in the display. In one embodiment an audible notification is given possibly reading out aloud the notification.

If a user chooses to press the softkey associated with the softkey label 410a indicating a SWITCH the user interface executes the profile switch in step 580 and notifies the user of this in step 590. The display view 403 will thus be updated to display a graphical indication 409 of the original or a new profile, in this example the graphical indication is the note. The softkey labels 410a and 410b are also updated to show the original functions, see FIG. 4E.

The profile switched to is in one embodiment the profile that was currently active as the other profile was automatically switched to in step 530.

In one embodiment it is a pre-specified profile independent of the profile in use before the automatic switch in step 530.

If a user chooses to press the softkey associated with the softkey label 410b indicating SNOOZE the user interface will postpone the scheduled time for the automatic profile switch in step 575 to a later time and return to step 550 to determine further times. In this example the scheduled switch is postponed until 12:10 which is indicated in the graphical indication 409′, see FIG. 4F. Also the softkey labels 410 are updated to display the original functions. This enables a user to keep the scheduled profile active for an extended time should the scheduled event or meeting not end according to plan.

In one embodiment the user interface is configured to switch profile automatically in step 580 if no user input is received in step 570 within a pre-determined time from displaying the notification 412. In other words, if a time out period lapses the profile is switched automatically. This provides a user interface that automatically switches back from the scheduled profile without requiring user attention which can help a user avoid forgetting to switch back to for example an audible profile when leaving a meeting.

In one embodiment the scheduled switch is postponed if no user input is received. This allows a user to maintain the appropriate profile for an extended time without taking explicit action which could interrupt the meeting or the user's focus.

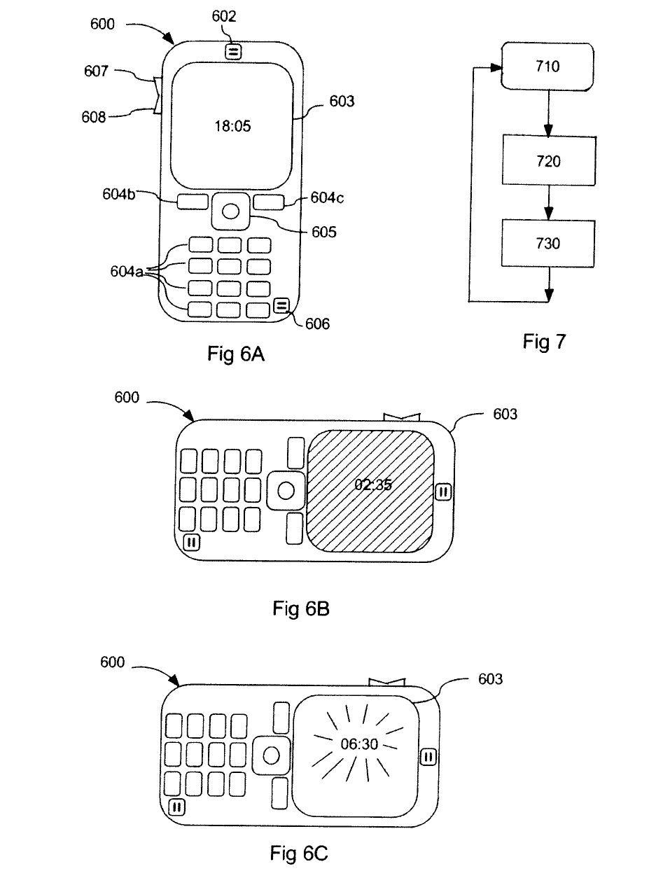

FIG. 6A shows a device 600 according to the teachings herein. The device 600 is, in this exemplary embodiment, a mobile phone such as is described with reference to FIG. 2 and incorporates a user interface being coupled to a display 603. The user interface is further configured to offer a user at least one operating mode also referred to as profiles. These profiles comprise data structures which comprise control settings for controlling various aspects of a user interface. Different profiles differ in the control settings and a user interface will thus operate differently depending on which profile or operating mode is currently active.

In this description only two operating modes or profiles will be described but it should be noted that many more are known in this field of technology.

As a device is operating under a normal profile, General, the display is illuminated so that a user can read what is displayed (in this example the time 18:05 is displayed) in normal daylight and the ringing tone setting is set so that a user can easily hear the phone as it rings and/or the phone is set to vibrate so that the user can feel the phone vibrating as a notification, for example for an incoming call, is given. To enable the screen content to be visible even under strong lighting a lot of power is used to illuminate the display enough which drains the battery rapidly. This is especially unnecessary and wasteful at night when the phone is not looked at.

A special operating mode or profile is implemented according to the teachings herein to reduce the power drainage and to not disturb the user or his surrounding with a too bright light. This profile will be referred to hereafter as a night profile or a night mode, but it should be understood that it is not solely for use during night hours.

The control settings for the night profile are designed to illuminate the display 603 with colors that are easily detectable at night and which do not ruin the night vision. Such colors are also less prone to disturb the surroundings. Examples of such colors are different shades of blue and red. Using these colors on contrasting background enables a user to read the display easily without requiring the display 603 to be fully lit, a reduction in power use is thus achieved and the device can be active for a longer period of time. This allows for a user to check the display without actively reaching for the device to activate it.

In one embodiment the display is controlled to increase the contrast of the displayed content which also enables a user to read the content more easily under poor light conditions.

As can be seen in FIG. 6B the display is not brightly illuminated (indicated by the shaded display). This causes a reduction in the power consumption which allows the phone 600 to remain active for longer periods of time thereby providing easy access to the displayed content without a user having to activate the user interface and thereby the display 603. The display 603 is thus also more discrete which has a reduced influence on the surroundings and reduces the disturbance that is otherwise caused by a brightly illuminated display in an otherwise dark environment.

To further reduce the power drain functions that are not actively needed during the night may be turned off. One such example is the regular update of the network to check the signal and connection with a base station which can be done less regularly as it is unlikely to change during the night.

In one embodiment the phone 600 is arranged with motion sensors operatively coupled to the user interface. Such motion sensors are commonly known and can be implemented through the use of accelerometers, gyroscopes or other known alternatives. Through the motion data received from the motion sensors the user interface is configured to detect a position change of the device 600 and to switch profile accordingly.

In one embodiment the night mode is activated as the phone 600 is laid on its side. This is the case in FIG. 6B. It should be noted that the user interface of the device has been configured to automatically change the display view so as the phone is laid on its side so that the text being displayed (in this example 02:35) is shown correctly to a user looking at the phone 600.

The night mode is beneficially combined with an alarm clock application as are currently known. Such an alarm clock application could be automatically activated as the night profile is activated.

A user can thus activate the night profile and the alarm clock simultaneously simply by placing the phone 600 on its side. As the alarm goes off the display is lit up brightly to attract further attention and add to the arousing effect of sounding the alarm. In FIG. 6C the brighter illumination is indicated by the lines emanating from the displayed time (06:30) on the display 603.

In one embodiment the keypad 604 will also light up as the alarm goes off.

In one embodiment the user interface of the phone 600 will automatically switch to the profile used before the night profile was activated or to another possibly pre-specified profile when the alarm is deactivated.

In one embodiment the night mode is activated according to preset times, possibly controlled by a calendar application (360).

In one embodiment the device is configured to determine the surrounding light level and to determine the surrounding noise or sound level. This can be implemented through the use of a camera commonly found in mobile phones (not shown) and the microphone 606. As the device 600 determines that the surrounding light level has been low for a predetermined time and at the same time the noise level has also been low the device and its user interface can be configured to activate the night profile. In this respect low is meant to be below a certain threshold value or that the integral over time of the light level or sound level is below a threshold value.

In one embodiment the night profile is only activated according to the surrounding light level.

In one embodiment the night profile is only activated according to the surrounding sound level.

FIG. 7 shows a flow chart of a method according to the teachings herein and begins in an initial step 710 where the phone 600 is in one profile. As a profile switch is detected in step 720 indicating that the night profile should be activated the phone's display 603 is changed so as to display the content in a suitable color and/or in higher contrast.

The profile switch can be caused by an explicit command, a time reference, an associated calendar event or a position change as has been described above.

In a step 730 the phone 600 switches to another profile, possibly being the original profile and the display is reset. This profile switch can also be caused by an explicit command, a time reference, an associated calendar event, a position change or through an alarm clock application as has been described above.

In one embodiment the profile is automatically switched back to the original operation mode or to a pre-determined mode as the user interface receives further motion data and determines that the phone 600 is no longer lying on its side.

In one embodiment the volume keys 607 and 608 can be used to snooze the alarm as they re easy to access if they are arranged on a side which the phone 600 is not resting on.

In one embodiment the night profile as described above is beneficially combined with the automatic switching of profiles as is also described above. FIG. 8 is a flow chart of an exemplary method of one such combination of the embodiments described above.

In one embodiment a user interface implementing a night operation mode or profile that is scheduled to automatically switch to another profile at a scheduled time by setting this scheduled time to be the alarm time used in the alarm clock application. As the determined time in step 550 equals the alarm time for the alarm clock application the automated profile switch is initiated at the same time as the alarm clock sounds its alarm (step 860) and the notification 412 showed in step 870 is the same notification as is shown for the alarm clock application. As a user chooses to snooze the alarm clock application the profile switch is also postponed in step 875 and a new alarm time is shown in the graphical indication 409′.

If a user chooses to turn off the alarm the profile switch is also automatically switched in step 880 and the user is notified of the new profile in step 890 analogously to step 590.

In this embodiment the timeout function as described below is implemented to postpone the alarm and the profile switch as is indicated by the arrow marked T.O. from step 870 to step 875.

In this embodiment the steps of FIG. 8 are executed analogously to the steps in FIG. 5B.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, MP3 players, personal organizers or any other device designed for providing more than none operating modes.

The teaching of the present application has numerous advantages. Different embodiments or implementations may yield one or more of the following advantages. It should be noted that this is not an exhaustive list and there may be other advantages which are not described herein. One advantage of the teaching of this application is that a user interface or a device provides a user with an intuitive and easy to learn and use manner of switching profiles according to scheduled events to always have an appropriate profile or operating mode active in a user interface on a device.

Another advantage of the teaching of the present application is that a user can easily reduce the power drain or consumption of a device and to reduce the device's influence on the surroundings while still maintaining access to the data being displayed and access to the functions that are deemed necessary.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as music players, palmtop computers and the like. It should also be noted that there are many alternative ways of implementing the methods and apparatuses of the teachings of the present application.

The term “comprising” as used in the claims does not exclude other elements or steps. The term “a” or “an” as used in the claims does not exclude a plurality. A unit or other means may fulfill the functions of several units or means recited in the claims.

1. A user interface for controlling a device according to a first and a second operating mode, said user interface is configured to automatically switch from said first to said second operating mode at a scheduled time, wherein said user interface is further configured to display a notification on a display, said notification indicating an option to postpone said automatic profile switch to a later scheduled time.

2. A user interface according to claim 1, further configured to receive user input and configured to automatically postpone said automatic profile switch if no user input is received within a time out period.

3. A user interface according to claim 1, further configured to receive user input and configured to automatically execute said automatic profile switch if no user input is received within a time out period.

4. A user interface according to claim 1, further configured to display a graphical indication of when said automatic profile switch is scheduled to be executed.

5. A user interface according to claim 1, wherein said notification is a pre-recorded or synthesized voice message.

6. A device incorporating and implementing or configured to incorporate and implement a user interface according to claim 1.

7. A computer readable medium stored in a memory including at least computer program code for controlling a user interface, said computer readable medium comprising:
software code for automatically switching from a first to a second operating mode at a scheduled time, and
software code for display a notification on a display, said notification indication an option to postpone said automatic profile switch to a later scheduled time.

8. A device incorporating and implementing a computer readable medium according to claim 7.

9. A method for automatically switching from a first operating mode to a second operating mode comprising determining whether a scheduled profile switch is to be executed,
displaying a notification on a display wherein said notification indicates an option to postpone said automatic switch,
receiving user input and executing said profile switch according to said user input.

10. A method according to claim 9, further comprising automatically postponing said automatic profile switch if no user input is received within a time out period.

11. A method according to claim 9, further comprising automatically executing said automatic profile switch if no user input is received within a time out period.

12. A method according to claim 9, further comprising displaying a graphical indication of when said automatic profile switch is scheduled to be executed.

13. A device incorporating and implementing or configured to incorporate and implement a method according to claim 9.

14. A data structure comprising control settings wherein said control settings include audio settings for notifications, vibra settings and display illumination settings.

15. A data structure according to claim 14 wherein said display illumination settings comprise at least one color setting and/or a contrast setting.

16. A data structure according to claim 14 further comprising settings for controlling execution of applications.

17. A user interface configured to incorporate a data structure according to claim 14 as an operating mode.

18. A user interface according to claim 17, further configured to receive motion data and from this motion data determine a position change and automatically switch to said operating mode according to said position change.

19. A user interface according to claim 17, further configured to receive light data and according to said light data automatically switch to said operating mode.

20. A user interface according to claim 17, further configured to receive sound data and according to said sound data automatically switch to said operating mode.

21. A user interface according to claim 17, further configured to activate an alarm clock application as said operating mode is switched to.

22. A user interface according to claim 17, further configured to execute a scheduling application and to switch to said operating mode according to a scheduled event comprised in said scheduling application.

23. A method for controlling a user interface, said method comprising activating an operating mode comprising a data structure according to claim 20 and controlling an illumination of a display according to control settings comprised in said data structure.

24. A method according to claim 23 further comprising receiving motion data and from this motion data determine a position change and automatically switch to said operating mode according to said position change.

25. A method according to claim 23 further comprising receiving light data and according to said light data automatically switch to said operating mode.

26. A method according to claim 23 further comprising receiving sound data and according to said sound data automatically switch to said operating mode.

27. A device incorporating and implementing or configured to incorporate and implement a method according to claim 23.

28. A computer readable medium including at least computer program code for controlling a user interface, said computer readable medium comprising software code for activating an operating mode comprising a data structure according to claim 17 and controlling an illumination of a display according to control settings comprised in said data structure.

29. A user interface for controlling a device according to a first and a second operating mode, said user interface is configured to automatically switch from said first to said second operating mode at a scheduled time, wherein said user interface is further configured to display a notification on a display, said notification indicating an option to postpone said automatic profile switch to a later scheduled time, wherein said first operating mode comprises a data structure comprising control settings wherein said control settings include audio settings for notifications, vibra settings and display illumination settings.
